(19) United States
(12) Patent Application Publication
(10) Pub. No.: US 2026/0079418 A1
(43) Pub. Date: Mar. 19, 2026

(54) BLACK TONER

(71) Applicant: CANON KABUSHIKI KAISHA, Tokyo (JP)

(72) Inventors: MASAYA KOMURO, Shizuoka (JP); MASATAKE TANAKA, Kanagawa (JP)

(21) Appl. No.: 19/320,076

(22) Filed: Sep. 5, 2025

(30) Foreign Application Priority Data
Sep. 17, 2024 (JP) 2024-159822

(51) Int. Cl. G03G 9/087; G03G 9/09

(52) U.S. Cl. CPC G03G 9/08724; G03G 9/0904; G03G 9/0918

(57) ABSTRACT

A black toner has a black toner particle having a binder resin, a hydrocarbon wax, and carbon black, the black toner particle further contains at least one selected from the group consisting of copper phthalocyanine and zinc phthalocyanine, and the binder resin includes a vinyl resin having a specific monomer unit having a linear alkyl group with 8 to 22 carbon atoms.

### BACKGROUND

### Field of the Technology

The present disclosure relates to a black toner for use in an image forming method such as electrophotography.

### Description of the Related Art

In recent years, there has been a demand for further reduction in power consumption in electrophotographic image forming apparatuses such as multifunction machines and printers. In terms of reducing costs, the decrease in the amount of heat applied to a fixing device has been considered from the perspective of reducing power consumption. As for toners, there is an increasing need for so-called toners with low-temperature fixability that can be fixed with less heat. In order to meet such demands, various studies have been conducted on binder resins used in toners. Among them, a resin incorporating a long-chain alkyl (meth)acrylate has been considered as a binder resin with excellent melting characteristics.

For example, Japanese Patent Application Publication No. 2014-035506 discloses a black toner for developing electrostatic images, which contains a crystalline ester compound and a styrene-acrylic resin having a structural unit derived from a (meth)acrylic acid alkyl ester monomer having an alkyl group with 8 to 22 carbon atoms. Furthermore, Japanese Patent Application Publication No. 2014-035506 discloses that paraffin wax can be used in combination as a hydrocarbon wax.

### SUMMARY

Using a styrene-acrylic resin in Japanese Patent Application Publication No. 2014-035506 makes it possible to control the affinity between the crystalline ester compound and the binder resin, improve the melting characteristics of the toner, and lower a cold offset generation temperature.

The inventors therefore used the toner of Japanese Patent Application Publication No. 2014-035506 to output an image on plain paper with unevenness on the paper. As a result, the inventors recognized that, particularly in areas where pressure from a fixing film is difficult to apply, such as recesses in the paper, the toner adheres to the fixing film side and is removed from the paper, resulting in blank dots which are white spots where the image area is missing.

The present disclosure provides a black toner that suppresses the occurrence of both cold offset and blank dots. Specifically, the present disclosure provides a black toner that can suppress the occurrence of blank dots even when a solid image is printed using plain paper.

The inventors have investigated a method making it possible to suppress the occurrence of both cold offset and blank dots. It was found that the above problem can be solved by the following black toner.

The present disclosure relates to a black toner comprising a black toner particle comprising a binder resin, a hydrocarbon wax, and carbon black, wherein the black toner particle further comprises at least one selected from the group consisting of copper phthalocyanine and zinc phthalocyanine, and the binder resin comprises a vinyl resin having a monomer unit represented by the following formula (1):

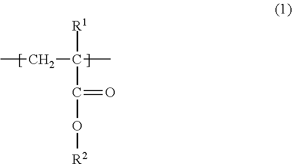

where in formula (1), R¹ represents a hydrogen atom or a methyl group, and R² represents a linear alkyl group having 8 to 22 carbon atoms.

Features of the present disclosure will become apparent from the following description of embodiments. The following description of embodiments are described by way of example.

### DESCRIPTION OF THE EMBODIMENTS

In the present disclosure, the wordings of “from XX to YY” and “XX to YY” that represent a numerical range mean a numerical range including the lower and upper limits, which are the endpoints, unless otherwise specified. When the numerical range is described in stages, the upper and lower limits of each numerical range can be combined in any way. In addition, in this disclosure, for example, a wording such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ. Note that when XX is a group, a plurality of XX may be selected, and the same applies to YY and ZZ.

“Monomer unit” refers to the reacted form of a monomer substance in a polymer. For example, one section of a carbon-carbon bond in the main chain of a polymer in which a vinyl monomer is polymerized is considered to be one unit. A vinyl monomer can be represented by the following formula (V).

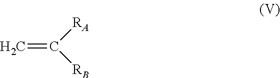

In formula (V), R_{A} represents a hydrogen atom or an alkyl group (preferably an alkyl group having 1 to 3 carbon atoms, more preferably a methyl group), and R_{B} represents any substituent.

The present disclosure relates to a black toner comprising a black toner particle comprising a binder resin, a hydrocarbon wax, and carbon black, wherein the black toner particle further comprises at least one selected from the group consisting of copper phthalocyanine and zinc phthalocyanine, and the binder resin comprises a vinyl resin having a monomer unit represented by the following formula (1):

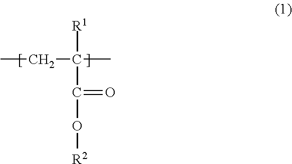

where in formula (1), R¹ represents a hydrogen atom or a methyl group, and R² represents a linear alkyl group having 8 to 22 carbon atoms.

The black toner described above can suppress cold offset, and blank dots are less likely to occur when solid images are printed on plain paper. The inventors believe that the mechanism by which this effect is obtained is as follows.

As described above, vinyl resins having a monomer unit represented by formula (1) have high melting properties, so cold offset can be suppressed and low-temperature fixability is improved.

Meanwhile, the following mechanism is considered for suppressing blank dots. In a system in which a vinyl resin having a monomer unit represented by formula (1) is used in combination with carbon black, an interface is present between the vinyl resin chain containing the monomer unit represented by formula (1) and the carbon black. Hydrocarbon wax, which is compatible with carbon black, is stabilized at this interface. This stabilization effect makes the hydrocarbon wax more compatible with toner materials such as a binder resin.

When the hydrocarbon wax becomes more compatible with toner materials, it aggregates and crystallizes, making it impossible to separate from the toner, and it is not possible to exert a sufficient release effect during fixing. For this reason, when printing is performed using plain paper with an uneven surface, in areas where pressure is unlikely to be applied, such as the recesses of the paper, the toner is not pressed sufficiently against the paper and remains attached to the fixing film side, which is thought to result in blank dots.

In the present disclosure, the black toner particle contains at least one selected from the group consisting of copper phthalocyanine and zinc phthalocyanine (hereinafter simply referred to as a “phthalocyanine compound”). Copper phthalocyanine and zinc phthalocyanine are metal complexes with high planarity and have π electrons derived from phthalocyanine. In addition, when focusing on the surface structure of carbon black, carbon black has a planar structure similar to graphite and π electrons are abundantly present therein.

The phthalocyanine in the phthalocyanine complex has π electrons that are strongly attracted to the central metal ion, resulting in an electron deficiency. For this reason, it is thought that phthalocyanine seeks π electrons on the carbon black and is more likely to penetrate to the interface between the vinyl resin chain and the carbon black described above before the hydrocarbon wax. The hydrocarbon wax loses its place in the interface because the interface has been occupied before, and the compatibility of the hydrocarbon wax with the toner material decreases. Therefore, in the toner, the hydrocarbon wax aggregates, crystallizes, and is easily separated. It is thought that, as a result, the release effect of the hydrocarbon wax can be fully exerted during fixing, the toner remains on the paper side even in the recesses of the paper, and the occurrence of blank dots is suppressed.

The black toner particle contains a vinyl resin as a binder resin. The vinyl resin has a monomer unit represented by formula (1). The vinyl resin having a monomer unit represented by formula (1) is, for example, at least one resin selected from the group consisting of styrene resin, acrylic resin, styrene acrylic resin, polyethylene resin, polyethylene vinyl acetate resin, vinyl acetate resin, polybutadiene resin, etc. The vinyl resin having a monomer unit represented by formula (1) is preferably a styrene acrylic resin having a monomer unit represented by formula (1).

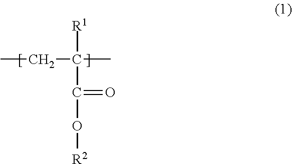

In formula (1), R¹ represents a hydrogen atom or a methyl group. R² is a linear alkyl group having 8 to 22 carbon atoms. R² is preferably a linear alkyl group having 12 to 22 carbon atoms. If R² is, for example, a 2-ethylhexyl group having a side chain, instead of the structure represented by formula (1), the interface is likely to have a three-dimensionally crowded structure. Therefore, it is considered that only hydrocarbon waxes having a more flexible structure than phthalocyanines penetrate to the interface and become compatible with the toner, and the occurrence of blank dots cannot be suppressed.

A monomer forming the monomer unit represented by formula (1) (hereinafter also referred to as “formula (1) unit monomer”) is, for example, a (meth)acrylic acid alkyl ester having a linear alkyl group having 8 to 22 carbon atoms (preferably 12 to 22).

The vinyl resin contains, for example, 0.5% by mass to 20.0% by mass, preferably 1.0% by mass to 15.0% by mass, and more preferably 4.0% by mass to 10.0% by mass of the monomer unit represented by formula (1).

When the vinyl resin contains 1.0% by mass or more of the monomer unit represented by formula (1), the melting characteristics of the toner are improved, and the toner can be fixed at a lower temperature. Meanwhile, when the vinyl resin contains 15.0% by mass or less of the monomer unit represented by formula (1), the number of interfaces between the vinyl resin chain containing the monomer unit represented by formula (1) and the carbon black can be kept constant, and the occurrence of blank dots can be further suppressed.

Examples of vinyl resins include homopolymers made of the following polymerizable monomers, copolymers obtained by combining two or more of these, and mixtures thereof.

Examples thereof include styrenic monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, 2-benzoyloxyethyl (meth)acrylate, (meth)acrylonitrile, 2-hydroxyethyl (meth)acrylate, (meth)acrylic acid, and maleic acid;
vinyl ether monomers such as vinyl methyl ether and vinyl isobutyl ether; vinyl ketone monomers such as vinyl methyl ketone, vinyl ethyl ketone, and vinyl isopropenyl ketone; polyolefins such as ethylene, propylene, and butadiene.

For a vinyl resin, a polyfunctional polymerizable monomer can be used as needed. Examples of polyfunctional polymerizable monomers include diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl)propane, trimethylolpropane tri(meth)acrylate, tetramethylolmethane tetra(meth)acrylate, divinylbenzene, divinylnaphthalene, and divinyl ether.

The vinyl resin is preferably a polymer of a monomer mixture containing at least one selected from the group consisting of (meth)acrylic monomers and also styrene and a unit monomer of formula (1). The vinyl resin is more preferably a polymer of a monomer mixture containing a unit monomer of formula (1), styrene, and n-butyl (meth)acrylate.

The content ratio of the monomer unit corresponding to styrene in the vinyl resin is preferably 50.0% by mass to 95.0% by mass, and 60.0% by mass to 85.0% by mass.

The content ratio of the monomer unit corresponding to the (meth)acrylic monomer (preferably n-butyl (meth)acrylate) in the vinyl resin is preferably 5.0% by mass to 40.0% by mass, and 10.0% by mass to 25.0% by mass.

In order to control the degree of polymerization of the vinyl resin, it is also possible to further add known chain transfer agents and polymerization inhibitors.

Examples of polymerization initiators for obtaining the vinyl resin include organic peroxide initiators and azo polymerization initiators.

Examples of organic peroxide initiators include benzoyl peroxide, lauroyl peroxide, di-α-cumyl peroxide, 2,5-dimethyl-2,5-bis(benzoylperoxy)hexane, bis(4-t-butylcyclohexyl)peroxydicarbonate, 1,1-bis(t-butylperoxy)cyclododecane, t-butylperoxymaleic acid, bis(t-butylperoxy)isophthalate, methyl ethyl ketone peroxide, tert-butylperoxy-2-ethylhexanoate, diisopropyl peroxycarbonate, cumene hydroperoxide, 2,4-dichlorobenzoyl peroxide, and tert-butylperoxypivalate.

Examples of azo polymerization initiators include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, and 2,2′-azobis-(methyl isobutyrate).

In addition, redox initiators in which an oxidizing substance is combined with a reducing substance can also be used as polymerization initiators.

Examples of oxidizing substances include inorganic peroxides such as hydrogen peroxide and persulfates (sodium salts, potassium salts, and ammonium salts), and oxidizing metal salts such as tetravalent cerium salts.

Examples of reducing substances include reducing metal salts (divalent iron salts, monovalent copper salts, and trivalent chromium salts), ammonia, lower amines (amines with a number of carbon atoms of about from 1 to 6, such as methylamine and ethylamine), amino compounds such as hydroxylamine, reducing sulfur compounds such as sodium thiosulfate, sodium hydrosulfite, sodium hydrogensulfite, sodium sulfite, and sodium formaldehyde sulfoxylate, lower alcohols (with a number of carbon atoms from 1 to 6), ascorbic acid or salts thereof, and lower aldehydes (with a number of carbon atoms from 1 to 6).

Polymerization initiators are selected with reference to a 10-hour half-life temperature thereof and are used alone or in combination. The amount of polymerization initiator added varies depending on the desired degree of polymerization, but generally from 0.5 parts by mass to 20.0 parts by mass are added per 100.0 parts by mass of polymerizable monomers.

The black toner particle may contain a binder resin other than the vinyl resin having a monomer unit represented by formula (1). There are no particular limitations on the binder resin other than the vinyl resin having a monomer unit represented by formula (1), and known resins such as those shown below can be used.

Styrene resin, acrylic resin, styrene acrylic resin, polyethylene resin, polyethylene vinyl acetate resin, vinyl acetate resin, polybutadiene resin, phenol resin, polyurethane resin, polybutyral resin, polyester resin, epoxy resin, polyamide resin, cellulose resin, polyether resin, mixed resins and composite resins thereof, etc.

Among these, styrene resin, acrylic resin, styrene acrylic resin, etc. are preferred from the viewpoint of toner properties.

The binder resin preferably contains 50% by mass or more of the vinyl resin having the monomer unit represented by formula (1), more preferably 70% by mass or more, and even more preferably 80% by mass or more. Furthermore, the binder resin preferably contains 50% by mass to 100% by mass, more preferably 70% by mass to 95% by mass, and even more preferably 80% by mass to 95% by mass of the vinyl resin having a monomer unit represented by formula (1).

The toner particle is a black toner particle containing carbon black.

The carbon black content is, for example, 3.0 parts by mass to 30.0 parts by mass, preferably 5.0 parts by mass to 25.0 parts by mass, and more preferably 5.0 parts by mass to 17.0 parts by mass, relative to 100 parts by mass of the binder resin. As a result of containing 5.0 parts by mass or more of carbon black, the toner has particularly excellent tinting strength and can form a high-density image. Meanwhile, by containing 25.0 parts by mass or less of carbon black, the amount of hydrocarbon wax drawn to the interface can be minimized, the release effect can be fully exerted, and the occurrence of blank dots can be further suppressed.

The carbon black is obtained by a method such as furnace black, gas black, thermal black, acetylene black, lamp black, etc. manufacturing method, and the manufacturing method is not particularly limited. In other words, it is preferable that the carbon black be at least one selected from the group consisting of furnace black, gas black, thermal black, acetylene black, lamp black, etc.

The black toner particle contains at least one selected from the group consisting of copper phthalocyanine and zinc phthalocyanine.

The total content of copper phthalocyanine and zinc phthalocyanine is, for example, 0.05 parts by mass to 12.00 parts by mass, preferably 0.10 parts by mass to 8.00 parts by mass, and more preferably 0.15 parts by mass to 8.00 parts by mass, relative to 100 parts by mass of the binder resin.

When the content of copper phthalocyanine and zinc phthalocyanine is 0.10 parts by mass or more, a sufficient amount of phthalocyanine complex is supplied to the interface, making it possible to further suppress the occurrence of blank dots. Meanwhile, when the content of copper phthalocyanine and zinc phthalocyanine is 8.00 parts by mass or less, carbon black to which the phthalocyanine complex is excessively bonded seeks electrons and does not aggregate with other carbon black particles, making it possible to output a high-density image.

The content of carbon black based on the mass of the black toner particle is denoted by a (% by mass), and the total content of copper phthalocyanine and zinc phthalocyanine based on the mass of the black toner particle is denoted by b (% by mass). In this case, a/b is, for example, 0.5 to 120.0. In addition, it is preferable that a and b satisfy the following formula (2):

$$2. \leq a / b \leq 30. \qquad ( 2 )$$

When the value of a/b is within the range of formula (2), the carbon black and the phthalocyanine complex can act more efficiently, and the effect of suppressing blank dots can be maximized.

It is more preferable that a/b be 5.0 to 20.0.

The black toner particle contains a hydrocarbon wax.

The content of the hydrocarbon wax is, for example, 0.5 parts by mass to 18.0 parts by mass, and preferably 1.5 parts by mass to 15.0 parts by mass, relative to 100 parts by mass of the binder resin. When the content of the hydrocarbon wax is 1.5 parts by mass or more, sufficient release property is exhibited during fixing, and both cold offset and blank dots are more easily suppressed. Meanwhile, when the content of the hydrocarbon wax is 15.0 parts by mass or less, a part of the hydrocarbon wax is more easily prevented from stabilizing at the interface and becoming compatible with the toner. Therefore, the wax is less likely to crystallize in the image after fixing, and the gloss is good.

The hydrocarbon wax may be at least one selected from the group consisting of petroleum waxes such as paraffin wax, microcrystalline wax, and petrolatum, and Fischer-Tropsch wax. The hydrocarbon wax includes, for example, paraffin wax.

The black toner particle may also contain a release agent other than the hydrocarbon wax. Examples of the other release agents include alcohols such as higher aliphatic alcohols; fatty acids such as stearic acid and palmitic acid or acid amides, esters, and ketones thereof; hydrogenated castor oil and derivatives thereof, vegetable waxes, and animal waxes.

The black toner particle preferably contains a first ester compound which is at least one ester compound selected from the group consisting of ester compounds represented by the following formula (3), ester compounds represented by the following formula (4), and ester compounds represented by the following formula (5), and a second ester compound which is at least one ester compound selected from the group consisting of ester compounds represented by the following formula (6), ester compounds represented by the following formula (7), and ester compounds represented by the following formula (8).

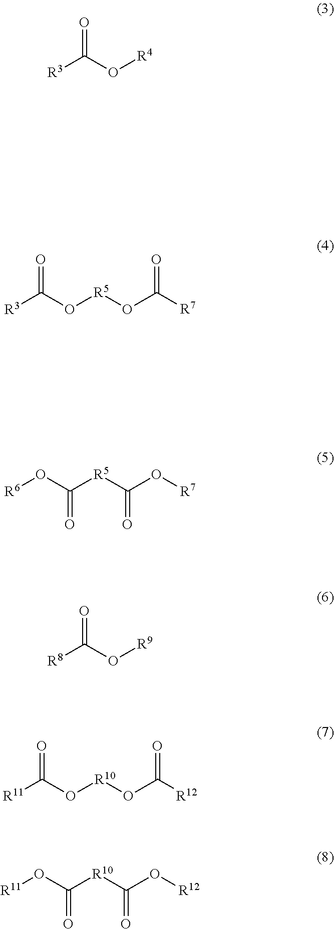

In formula (3), R³ and R⁴ each independently represent, for example, a linear alkyl group having 15 to 22 carbon atoms, preferably a linear alkyl group having 16 to 22 carbon atoms (however, when R³ has 18 to 22 carbon atoms, this does not include the case where R⁴ has 19 to 22 carbon atoms).

In formula (4), R⁵ represents, for example, a linear alkylene group having 1 to 7 carbon atoms, preferably a linear alkylene group having 1 to 6 carbon atoms (more preferably 1 to 4 or 1 to 3), and R⁶ and R⁷ each independently represent, for example, a linear alkyl group having 14 to 24 carbon atoms, preferably a linear alkyl group having 14 to 22 carbon atoms (more preferably 16 to 22).

In formula (5), R⁵ represents, for example, a linear alkylene group having 1 to 7 carbon atoms, preferably a linear alkylene group having 1 to 6 carbon atoms (more preferably 1 to 4 or 1 to 3), and R⁶ and R⁷ each independently represent, for example, a linear alkyl group having 14 to 24 carbon atoms, preferably a linear alkyl group having 14 to 22 carbon atoms (more preferably 16 to 22).

In formula (6), R⁸ represents a linear alkyl group having 21 carbon atoms, and R⁹ represents a linear alkyl group having 22 carbon atoms.

In formula (7), R¹⁰ represents, for example, a linear alkylene group having 8 to 14 carbon atoms, preferably a linear alkylene group having 8 to 12 carbon atoms, and R¹¹ and R¹² each independently represent, for example, a linear alkyl group having 18 to 24 carbon atoms, preferably a linear alkyl group having 18 to 22 carbon atoms.

In formula (8), R¹⁰ represents, for example, a linear alkylene group having 8 to 14 carbon atoms, preferably a linear alkylene group having 8 to 12 carbon atoms, and R¹¹ and R¹² each independently represent, for example, a linear alkyl group having 18 to 24 carbon atoms, preferably a linear alkyl group having 18 to 22 carbon atoms.

As a result of having an ester compound represented by formulas (3) to (5), the melting characteristics of the toner are improved, making it possible to fix the toner at a lower temperature. Meanwhile, as a result of having an ester compound represented by formulas (6) to (8), the release property of the toner is improved, and this is particularly effective in terms of suppressing the occurrence of blank dots. In addition, an action is exerted on the ester compound represented by formulas (3) to (5) to prevent the ester compound represented by formulas (3) to (5) from crystallizing on the image after fixing, thereby preventing a decrease in gloss.

The black toner particle preferably contains a polyvalent metal element. The polyvalent metal element preferably contains at least one selected from the group consisting of aluminum and magnesium. The mass concentration of the polyvalent metal element in the black toner particle is, for example, 5 ppm to 700 ppm, and preferably 5 ppm to 500 ppm.

Aluminum and magnesium interact with hydroxyl groups on the carbon black surface to attract electrons, making it easier for the electron-deficient carbon black to attract phthalocyanine complexes to the interface, which helps to separate the hydrocarbon wax. When the mass concentration of the polyvalent metal element in the toner particle is 5 ppm or more, aluminum or magnesium acts on the carbon black and works sufficiently to help the separation of the hydrocarbon wax. Meanwhile, where the mass concentration of the polyvalent metal element in the toner particle is 500 ppm or less, there is no excessive action of aluminum or magnesium on the carbon black that can prevent the phthalocyanine complex from penetrating to the interface, and the hydrocarbon wax can be reliably separated.

These polyvalent metal elements can be introduced into the black toner particle by using a metal salt as a flocculant when producing the toner particle by the emulsion aggregation method, or by adding the metal salt as an organometallic compound to the oil layer when producing the toner particle by the suspension polymerization method.

It is preferable to use aluminum distearate as a means for introducing the polyvalent metal element. In other words, it is preferable that the black toner particle contain aluminum distearate. Aluminum distearate disperses well in the binder resin and acts on the pigment to improve the dispersibility of the pigment, thereby improving the tinting strength of the toner.

The components constituting the black toner and a production method for the black toner will be explained hereinbelow in more detail.

### Binder Resin

The black toner particle includes, as a binder resin, a vinyl resin having a monomer unit represented by the following formula (1). As described above, the black toner particle may contain other binder resins as necessary. Examples of other binder resins include polyester resins.

A polyester resin is obtained by selecting and combining suitable components from among polycarboxylic acids, polyols, hydroxycarboxylic acids, etc., and conducting synthesis using a known method such as transesterification method or a polycondensation method.

Polycarboxylic acids are compounds that contain two or more carboxy groups in one molecule. Of these, dicarboxylic acids are compounds that contain two carboxy groups in one molecule and are preferably used.

Examples of dicarboxylic acids include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylene diacetic acid, o-phenylene diacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracene dicarboxylic acid, and cyclohexane dicarboxylic acid.

Examples of polyvalent carboxylic acids other than the dicarboxylic acids include trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid, n-octenyl succinic acid, etc. These may be used alone or in combination of two or more.

Polyols are compounds that contain two or more hydroxyl groups in one molecule. Of these, diols are compounds that contain two hydroxyl groups in one molecule and are preferably used.

Specific examples of polyols include ethylene glycol, diethylene glycol, triethylene glycol, 1,2-propylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, diethylene glycol, triethylene glycol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, 1,4-cyclohexanediol, polytetramethylene glycol, hydrogenated bisphenol A, bisphenol A, bisphenol F, bisphenol S, alkylene oxide (ethylene oxide, propylene oxide, butylene oxide, etc.) adducts of the above bisphenols, etc.

Among these, preferred are alkylene glycols having 2 to 12 carbon atoms and alkylene oxide adducts of bisphenols, and particularly preferred are alkylene oxide adducts of bisphenols and combinations thereof with alkylene glycols having 2 to 12 carbon atoms.

Examples of trihydric or higher polyols include glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the above trivalent or higher polyphenols. These may be used alone or in combination of two or more. The polyester resin may be a polyester resin containing a urea group. It is preferable that the carboxyl groups at the terminals of the polyester resin are not capped.

The binder resin may also contain a crystalline polyester. Examples of crystalline polyesters include condensation polymers of aliphatic diols and aliphatic dicarboxylic acids.

A polycondensate of an aliphatic diol having from 2 to 12 carbon atoms and an aliphatic dicarboxylic acid having from 2 to 12 carbon atoms is preferred.

The following compounds can be mentioned as examples of the aliphatic diol having from 2 to 12 carbon atoms: 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, etc.

Furthermore, an aliphatic diol having a double bond can also be used. The following compounds can be mentioned as examples of the aliphatic diol having a double bond: 2-butene-1,4-diol, 3-hexene-1,6-diol, and 4-octene-1,8-diol.

The following compounds can be mentioned as examples of the aliphatic dicarboxylic acids having from 2 to 12 carbon atoms: oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, and lower alkyl esters and acid anhydrides of these aliphatic dicarboxylic acids.

Of these, sebacic acid, adipic acid, and 1,10-decanedicarboxylic acid, as well as lower alkyl esters and acid anhydrides thereof, are preferred. These may be used alone, or two or more of them may be used in combination.

Aromatic dicarboxylic acids can also be used. Examples of aromatic dicarboxylic acids include the following compounds: terephthalic acid, isophthalic acid, 2,6-naphthalenedicarboxylic acid, and 4,4′-biphenyldicarboxylic acid. Among these, terephthalic acid is preferred because it is easily available and can easily form a polymer with a low melting point.

Dicarboxylic acids having a double bond can also be used. Dicarboxylic acids having a double bond can be suitably used to suppress hot offset during fixing because the double bond can be used to crosslink the entire resin.

Examples of such dicarboxylic acids include fumaric acid, maleic acid, 3-hexenedioic acid, and 3-octenedioic acid. Other examples include lower alkyl esters and acid anhydrides thereof. Among these, fumaric acid and maleic acid are more preferred.

There are no particular limitations on the method for producing the crystalline polyester, and it can be produced by a general polyester polymerization method in which a dicarboxylic acid component and a diol component are reacted. For example, the crystalline polyester can be produced by using a direct polycondensation method or a transesterification method, which are used depending on the type of monomer.

The content of the crystalline polyester in the binder resin is preferably from 1.0% by mass to 30.0% by mass, and more preferably from 3.0% by mass to 25.0% by mass.

The peak temperature of the maximum endothermic peak of the crystalline polyester measured using a differential scanning calorimeter (DSC) is preferably from 50.0° C. to 100.0° C., and from the viewpoint of low-temperature fixability, more preferably from 60.0° C. to 90.0° C.

The binder resin may contain an acid group-containing resin. The acid value of the acid group-containing resin is, for example, 2 mg KOH/g to 30 mg KOH/g, preferably 3 mg KOH/g to 25 mg KOH/g.

The acid group-containing resin is not particularly limited, and known resins such as those shown below can be used, but at least one selected from the group consisting of styrene acrylic resins and polyester resins is preferable.

The acid group-containing resin preferably contains a styrene acrylic resin. The styrene-acrylic resin may be exemplified by a polymer of a monomer mixture containing at least one selected from the group consisting of the above-mentioned (meth)acrylic monomers and styrene. The acid value can be controlled by using a monomer having an acid group, such as (meth)acrylic acid or maleic acid, in the monomer mixture.

The acid group-containing resin may be a polyester resin serving as a polar resin. Monomers for the polyester resin may be selected from the above-mentioned monomers, and it is preferable to select a monomer so that the acid value is 2 mg KOH/g to 30 mg KOH/g.

The content of the acid group-containing resin in the binder resin is preferably 2% by mass to 20% by mass, and 4% by mass to 15% by mass.

As for the molecular weight of the binder resin, a peak molecular weight Mp is preferably from 5,000 to 100,000, and more preferably from 10,000 to 40,000. The glass transition temperature Tg of the binder resin is preferably from 40° C. to 70° C.

### Crosslinking Agent

In order to control the molecular weight of the binder resin, a crosslinking agent may be added during polymerization of the polymerizable monomer.

Examples of the crosslinking agent include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene glycol #200, #400, #600 diacrylates, dipropylene glycol diacrylate, polypropylene glycol diacrylate, polyester type diacrylate (MANDA, Nippon Kayaku), and those in which the above acrylates have been replaced with methacrylates.

The amount of crosslinking agent added is preferably from 0.001 parts by mass to 15.000 parts by mass in relation to 100 parts by mass of polymerizable monomer.

### Charge Control Agent and Charge Control Resin

The black toner particle may contain a charge control agent or a charge control resin. Any known charge control agent can be used, and a charge control agent that has a high triboelectric charging rate and can stably maintain a constant triboelectric charge quantity is particularly preferred. Furthermore, when the toner particle is produced by a suspension polymerization method, a charge control agent that has a low polymerization inhibition property and is substantially free of matter solubilizable in an aqueous medium is particularly preferred.

Examples of materials that control the toner to be negatively charged include monoazo metal compounds, acetylacetone metal compounds, aromatic hydroxycarboxylic acid-, aromatic dicarboxylic acid-, hydroxycarboxylic and dicarboxylic acid-based metal compounds, aromatic hydroxycarboxylic acids, aromatic mono- and polycarboxylic acids and metal salts, anhydrides, esters, phenol derivatives such as bisphenol, and urea derivatives thereof, metal-containing salicylic acid compounds, metal-containing naphthoic acid compounds, boron compounds, quaternary ammonium salts, calixarenes, and charge control resins.

Examples of charge control resins include polymers or copolymers having sulfonic acid groups, sulfonic acid salt groups, or sulfonic acid ester groups. In particular, polymers including sulfonic acid group-containing acrylamide monomers or sulfonic acid group-containing methacrylamide monomers in a copolymerization ratio of 2% by mass or more are preferred, and polymers with such a copolymerization ratio of 5% by mass or more are more preferred as the polymers having sulfonic acid groups, sulfonic acid salt groups, or sulfonic acid ester groups.

The charge control resin preferably has a glass transition temperature (Tg) of from 35° C. to 90° C., a peak molecular weight (Mp) of from 10,000 to 30,000, and a weight-average molecular weight (Mw) of from 25,000 to 50,000. When a charge control resin is used, it is possible to provide desirable triboelectric charging characteristics without affecting the thermal characteristics required for the toner particle. Furthermore, when the charge control resin contains a sulfonic acid group, for example, the dispersibility of the charge control resin itself in the polymerizable monomer composition and the dispersibility of colorant and the like are improved, and it is possible to further improve the tinting strength, transparency, and triboelectric charging characteristics.

These charge control agents or charge control resins may be added alone or in combination of two or more types.

The amount of the charge control agent or charge control resin added is preferably from 0.01 parts by mass to 20.0 parts by mass, and more preferably from 0.5 parts by mass to 10.0 parts by mass, relative to 100.0 parts by mass of the binder resin.

### Production Method of Black Toner Particle

The production method of the black toner particle is not particularly limited and can be any known method, such as a kneading and pulverizing method or a wet production method. A wet production method is preferred from the viewpoints of uniform particle diameter, shape controllability, and ease of obtaining the toner particle with a core-shell structure. The toner particle may have a core particle containing a binder resin and a shell on the surface of the core particle. Wet production methods can be exemplified by a suspension polymerization method, a dissolution suspension method, an emulsion polymerization aggregation method, and an emulsion aggregation method. The suspension polymerization method is more preferable because it is easy to obtain the toner particle that satisfy the preferred physical properties of the present invention.

In the suspension polymerization method, first, a polymerizable monomer composition is obtained by uniformly dispersing a hydrocarbon wax, carbon black, and a phthalocyanine compound (and, if necessary, an ester compound, a polymerization initiator, a crosslinking agent, a charge control agent, and other additives) in a polymerizable monomer containing a unit monomer of formula (1). The resulting polymerizable monomer composition is then dispersed in a continuous layer (e.g., an aqueous phase) containing a dispersion stabilizer by using an appropriate stirrer, and a polymerization reaction is carried out using a polymerization initiator to obtain the toner particle having the desired particle diameter.

When producing the polymerizable monomer composition, a pigment dispersion liquid containing a portion of the polymerizable monomer, carbon black, and a phthalocyanine compound may be prepared in advance, and then the pigment dispersion liquid may be mixed with the remaining polymerizable monomer etc. to obtain the polymerizable monomer composition.

### Production Method of Black Toner

The black toner particle (hereinafter sometimes simply referred to as “toner particle”) may be used as they are as black toner. To improve flowability, charging performance, cleaning property, etc., so-called external additives such as a fluidizing agent and a cleaning aid may be added to the toner particle to obtain the toner.

Examples of external additives include inorganic fine oxide particles such as silica fine particles, alumina fine particles, and titanium oxide fine particles; inorganic stearic acid compound fine particles such as aluminum stearate fine particles and zinc stearate fine particles; and inorganic titanic acid compound fine particles such as strontium titanate and zinc titanate. These can be used alone or in combination of two or more.

It is preferable that these inorganic particles be gloss-treated with a silane coupling agent, a titanium coupling agent, a higher fatty acid, a silicone oil, or the like to improve heat-resistant storability and environmental stability. The BET specific surface area of the external additive is preferably from 10 m²/g to 450 m²/g.

The BET specific surface area can be determined by a low-temperature gas adsorption method using a dynamic constant pressure method according to a BET method (preferably a BET multipoint method). For example, a specific surface area measuring device (product name: Gemini 2375 Ver. 5.0, manufactured by Shimadzu Corporation) can be used to adsorb nitrogen gas onto the surface of a sample and measure it using the BET multipoint method to calculate the BET specific surface area (m²/g).

The total amount of these various external additives added is preferably from 0.05 parts by mass to 5 parts by mass, more preferably from 0.1 parts by mass to 3 parts by mass, relative to 100 parts by mass of toner particles. Various external additives may also be used in combination.

The toner can be used as a magnetic or non-magnetic one-component developer, but it may also be mixed with a carrier and used as a two-component developer. For example, magnetic particles made of known materials such as metals such as iron, ferrite, and magnetite, and alloys of these metals with metals such as aluminum and lead can be used as the carrier, and among these, it is preferable to use ferrite particles.

The carrier may be a coated carrier in which the surface of magnetic particles is coated with a coating agent such as resin, or a resin-dispersed carrier in which magnetic body fine powder is dispersed in a binder resin. The carrier preferably has a volume-average particle diameter of from 15 m to 100 m, more preferably from m to 80 m.

### Methods for Measuring the Physical Properties of the Toner and Each Material are Described Hereinbelow.

Method for Separating Binder Resin, Ester Compound, and Hydrocarbon Wax, and Method for Identifying Structure and Content Thereof Separation Method

The toner is dissolved in tetrahydrofuran (THF), and the solvent is removed from the resulting soluble matter by vacuum distillation to obtain a THF-soluble component of the toner. The resulting THF-soluble component of the toner is dissolved in chloroform to prepare a sample solution with a concentration of 25 mg/mL.

A total of 3.5 mL of the obtained sample solution is poured into the following device, and fractions with a number-average molecular weight (Mn) of less than 2000 are separated under the following conditions.
Preparative GPC device: Preparative HPLC LC-980 model, manufactured by Japan Analytical Industry Co., Ltd.
Preparative column: JAIGEL 3H, JAIGEL 5H (manufactured by Japan Analytical Industry Co., Ltd.)
Eluent: Chloroform
Flow rate: 3.5 mL/min

To calculate the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, manufactured by Tosoh Corporation) is used.

The components with a number-average molecular weight (Mn) of less than 2000 include the first ester compound, the second ester compound, and the hydrocarbon wax. Furthermore, components with a number-average molecular weight (Mn) of 2000 or more include binder resins such as vinyl resins having a monomer unit represented by formula (1) and acid group-containing resins.

Furthermore, if necessary, the components can be further fractionated using silica gel column chromatography (developing solvent: chloroform, toluene, hexane, methanol, etc.) or solids can be separated using a recrystallization method (solvent: acetone, hexane, etc.), after which the solvent is distilled off and drying by heating is performed under reduced pressure. The above operations are repeated until about 100 mg of each component is obtained.

### Identification of Structure and Content

The structure of the separated components is identified using nuclear magnetic resonance spectroscopy (¹H-NMR) [400 MHz, CDCl₃, room temperature (25° C.)].
Measurement device: FT NMR device JNM-EX400 (manufactured by JEOL Ltd.)
Measurement frequency: 400 MHz
Pulse conditions: 5.0 s
Frequency range: 10,500 Hz
Number of integrations: 64

The NMR measurement of the toner is also performed using the above method, and the contents of the first ester compound, second ester compound, hydrocarbon wax, and binder resin are obtained from the spectral intensity by comparing with each isolated component. This makes it possible to determine the number of parts by mass of each material, such as the hydrocarbon wax, relative to 100 parts by mass of the binder resin.

The content ratio of the monomer unit represented by formula (1) in the vinyl resin can also be calculated by the analysis using the ¹H-NMR.

### Measurement of Polyvalent Metal Element Content by X-Ray Fluorescence Analysis

A wavelength-dispersive X-ray fluorescence analyzer “Axios” (manufactured by PANalytical) and the accompanying dedicated software “SuperQ ver. 4.0F” (manufactured by PANalytical) for setting measurement conditions and analyzing measurement data are used. Rh is used as the anode of the X-ray tube, the measurement atmosphere is vacuum, the measurement diameter (collimator mask diameter) is 27 mm, and the measurement time is 10 sec. In addition, when measuring light elements, a proportional counter (PC) is used, and when measuring heavy elements, a scintillation counter (SC) is used for detection.

As the measurement sample, 4 g of toner particles are placed in a dedicated aluminum ring for pressing, flattened, and pressed at 20 MPa for 60 sec using a tablet molding compression machine “BRE-32” (manufactured by Maekawa Test Machinery Manufacturing Co., Ltd.) to form a pellet with a thickness of 2 mm and a diameter of 39 mm.

To quantify, the polyvalent metal to be quantified is added to 100 parts by mass of a resin sample that does not contain metal elements so that the amount is 5.0 ppm by mass, and the components are thoroughly mixed using a coffee mill. In the same manner, the polyvalent metal to be quantified is mixed with each resin sample so that the amount is 50.0 ppm, 500.0 ppm, and 5000.0 ppm, and these are used as samples for the calibration curve.

For each sample, a pellet of the calibration curve sample is prepared as described above using a tablet molding machine and measured. At this time, the acceleration voltage and current value of the X-ray generator are 24 kV and 100 mA, respectively. A linear calibration curve is obtained by plotting the count rate of the obtained X-rays on the ordinate and the amount of polyvalent metal added in each calibration curve sample on the abscissa.

Next, the toner particle to be analyzed are pelletized using a tablet molding machine as described above and measured. The polyvalent metal element content (mass concentration) in the black toner particle is then calculated from the calibration curve.

### Calculation of Net Intensity

The Net intensity is the X-ray intensity obtained by subtracting the background intensity from the X-ray intensity at the peak angle indicating the presence of the metal element, which is obtained by the above measurement.

### Separation of External Additives

Where the surface of the toner particle has been treated with an external additive or the like, the external additive can be removed as necessary by the following method to obtain the toner particle.

A total of 160 g of sucrose (manufactured by Kishida Chemical Co., Ltd.) is added to 100 mL of ion-exchanged water and dissolved in a hot water bath to prepare a concentrated sucrose solution. Then, 31 g of the concentrated sucrose solution and 6 mL of Contaminon N (a 10% by mass aqueous solution of a pH 7 neutral detergent for cleaning precision measuring instruments, which is composed of a nonionic surfactant, an anionic surfactant, and an organic builder; manufactured by Wako Pure Chemical Industries, Ltd.) are placed into a centrifuge tube (capacity 50 mL) to prepare a dispersion liquid. A total of 1.0 g of toner is added to this dispersion, and the toner lumps are broken up with a spatula or the like.

The centrifuge tube is shaken with a shaker at 350 spm (strokes per minute) for 20 min. After shaking, the solution is transferred to a glass tube for a swing rotor (capacity 50 mL) and separation is performed with a centrifuge (H-9R, manufactured by Kokusan Co., Ltd.) at 3,500 rpm for 30 minutes. This operation separates the toner particle from the external additives that have been removed. Sufficient separation of the toner and the aqueous solution is visually checked, and the toner particle that have separated to the top layer are collected with a spatula or the like. After filtering the collected toner particle with a vacuum filter, drying is performed with a dryer for at least 1 h to obtain the toner particle. This operation is carried out multiple times to ensure the required amount.

### Measurement of Acid Value

The acid value of the acid group-containing resin separated by the above-mentioned method can be measured by the following procedure.

The acid value is the number of milligrams of potassium hydroxide required to neutralize the acid contained in 1 g of sample. The acid value of resin is measured in accordance with JIS K 0070-1992, but specifically, it is measured according to the following procedure.

### (1) Preparation of Reagents

A total of 1.0 g of phenolphthalein is dissolved in 90 ml of ethyl alcohol (95 vol %), and ion-exchanged water is added to make 100 ml and obtain a phenolphthalein solution.

A total of 7 g of special grade potassium hydroxide is dissolved in 5 ml of water, and ethyl alcohol (95 vol %) is added to make 1 L. The solution is placed in an alkali-resistant container to avoid contact with carbon dioxide etc., allowed to stand for 3 days, and then filtered to obtain a potassium hydroxide solution. The obtained potassium hydroxide solution is stored in an alkali-resistant container. A total of 25 ml of 0.1 mol/L hydrochloric acid is placed in an Erlenmeyer flask, several drops of the phenolphthalein solution are added, titration is performed with the potassium hydroxide solution, and the factor of the potassium hydroxide solution is determined from the amount of the potassium hydroxide solution required for neutralization. The 0.1 mol/L hydrochloric acid used is prepared in accordance with JIS K 8001-1998.

### (2) Operations

### (A) Main Test

A total of 2.0 g of pulverize resin sample is weighed into a 200 ml Erlenmeyer flask, 100 ml of a toluene/ethanol (2:1) mixed solution is added, and dissolution is performed for 5 h. Next, a few drops of the phenolphthalein solution are added as an indicator, and titration is performed using the potassium hydroxide solution. The end point of the titration is when the light red color of the indicator continues for about 30 sec.

### (B) Blank Test

The titration is performed in the same manner as above, except that no sample is used (i.e., only a toluene/ethanol (2:1) mixed solution is used).

(3) the Results Obtained are Substituted into the Following Formula to Calculate the Acid Value.

$$A = [ ( C - B ) \times f \times 5.61 ] / S$$

Here, A: acid value (mg KOH/g), B: amount of potassium hydroxide solution added in the blank test (ml), C: amount of potassium hydroxide solution added in the main test (ml), f: factor of potassium hydroxide solution, S: mass of sample (g).

### Method for Measuring Weight-Average Particle Diameter (D4) of Toner

The weight-average particle diameter (D4) of toner is calculated in the following manner. The measuring device is a precision particle diameter distribution measuring device using the fine pore electrical resistance method, “Coulter Counter Multisizer 3” (registered trademark, manufactured by Beckman Coulter, Inc.), equipped with a 100 m aperture tube. The measurement conditions are set and the measurement data are analyzed using the provided dedicated software “Beckman Coulter Multisizer 3 Version 3.51” (manufactured by Beckman Coulter, Inc.). The measurements are performed with an effective measurement channel count of 25,000.

The electrolytic aqueous solution used for the measurements is prepared by dissolving special-grade sodium chloride in ion-exchange water to a concentration of 1% by mass; for example, “ISOTON II” (manufactured by Beckman Coulter, Inc.) can be used.

Before measurements and analysis, the dedicated software is set up in the following manner.

In the “Change Standard Measurement Method (SOMME)” screen of the dedicated software, the total count number in the control mode is set to 50,000 particles, the number of measurements is set to 1, and the Kd value is set to the value obtained using “Standard Particle 10.0 m” (manufactured by Beckman Coulter, Inc.). The threshold and noise level are automatically set by pressing the “Threshold/Noise Level Measurement Button.” In addition, the current is set to 1600 μA, the gain to 2, the electrolytic solution to ISOTON II, and “Flush aperture tube after measurement” is checked.

On the “Pulse to Particle Diameter Conversion Setting” screen of the dedicated software, the bin interval is set to logarithmic particle diameter, the particle diameter bin to 256 particle diameter bin, and the particle diameter range to from 2 m to 60 m.

The specific measurement method is as follows.

(1) A total of 200 ml of the electrolytic aqueous solution is poured into a 250 ml round-bottom glass beaker specific for the Multisizer 3, the beaker is set on a sample stand, and stirring with a stirrer rod is performed counterclockwise at 24 revolutions per second. Then, the “Aperture Tube Flush” function of the dedicated software is used to remove dirt and air bubbles from inside of the aperture tube.

(2) A total of 30 ml of the electrolytic aqueous solution is poured into a 100 ml flat-bottom glass beaker. Then, 0.3 ml of a diluted solution obtained by diluting “Contaminon N” (a 10% by mass aqueous solution of a pH 7 neutral detergent for cleaning precision measuring instruments, which is composed of a nonionic surfactant, an anionic surfactant, and an organic builder; manufactured by Wako Pure Chemical Industries, Ltd.) with 3 times by mass ion-exchanged water is added as a dispersant.

(3) An ultrasonic disperser “Ultrasonic Dispersion System Tetra 150” (manufactured by Nikkaki Bios Co., Ltd.) with an electrical output of 120 W and two oscillators with an oscillation frequency of 50 kHz built in with a phase shift of 180 degrees is prepared. A total of 3.3 L of ion-exchanged water is poured into the water tank of the ultrasonic disperser, and 2 ml of Contaminon N is added to the water tank.

(4) The beaker from (2) is set in a beaker fixing hole of the ultrasonic disperser, and the ultrasonic disperser is operated. Then, the height position of the beaker is operated so that the resonance state of the liquid surface of the electrolytic aqueous solution in the beaker is maximized.

(5) While the electrolytic aqueous solution in the beaker of (4) is irradiated with ultrasonic waves, 10 mg of toner is added little by little to the electrolytic aqueous solution and dispersed. Then, ultrasonic dispersion processing is continued for another 60 sec. During ultrasonic dispersion, the water temperature in the water tank is adjusted, as appropriate, to be from 10° C. to 40° C.

(6) Using a pipette, the electrolytic aqueous solution of (5) in which the toner has been dispersed is dropped into the round-bottomed beaker of (1) placed in the sample stand, and the measured concentration is adjusted to 5%. Then, measurements are performed until the number of measured particles reaches 50,000.

(7) The measurement data are analyzed using the dedicated software provided with the device, and the weight-average particle diameter (D4) is calculated. The “Average diameter” on the “Analysis/Volume Statistics (Arithmetic Mean)” screen when the dedicated software is set to graph/volume % is the weight-average particle diameter (D4).

### Method for Measuring Average Circularity

The average circularity of toner particles is measured using a flow-type particle image analyzer “FPIA-3000” (manufactured by Sysmex Corporation) under the measurement and analysis conditions during calibration work.

The specific measurement method is as follows. First, 20 ml of ion-exchanged water from which impurities such as solids have been removed in advance is placed in a glass container. A total of 0.2 ml of a diluted solution obtained by diluting “Contaminon N” (a 10% by mass aqueous solution of a pH 7 neutral detergent for cleaning precision measuring instruments, which is composed of a nonionic surfactant, an anionic surfactant, and an organic builder; manufactured by Wako Pure Chemical Industries, Ltd.) with 3 times by mass ion-exchanged water is added as a dispersant. Approximately 0.02 g of the measurement sample is then added, and the dispersion process is carried out for 2 min using an ultrasonic disperser to obtain the dispersion liquid for measurement. At this time, the dispersion liquid is cooled, as appropriate, so that the temperature is from 10° C. to 40° C. As the ultrasonic disperser, a tabletop ultrasonic cleaner-disperser (e.g., “VS-150” (manufactured by Velvo-Clear Co., Ltd.)) with an oscillation frequency of 50 kHz and an electric output of 150 W is used, a predetermined amount of ion-exchanged water is placed in the water tank, and 2 ml of Contaminon N is added to the water tank.

For the measurement, the flow type particle image analyzer equipped with “UPlanApro” (magnification 10 times, numerical aperture 0.40) as the objective lens is used, and particle sheath “PSE-900A” (manufactured by Sysmex Corporation) is used as a sheath liquid. The dispersion liquid prepared according to the above procedure is introduced into the flow type particle image analyzer, and 3000 toner particles are measured in an HPF measurement mode and a total count mode. Then, the binarization threshold during particle analysis is set to 85%, the analyzed particle diameter is limited to a circle-equivalent diameter of 1.985 m or more and less than 39.69 m, and the average circularity of the toner particles is obtained.

Before starting the measurement, automatic focus adjustment is performed using standard latex particles (for example, “RESEARCH AND TEST PARTICLES Latex Microsphere Suspensions 5200A” manufactured by Duke Scientific Corp., diluted with ion-exchanged water). After that, it is preferable to perform focus adjustment every two hours from the start of the measurement.

In the examples of the present application, the flow-type particle image analyzer that was calibrated by Sysmex Corporation and had a calibration certificate issued by Sysmex Corporation was used. Measurements were performed under the measurement and analysis conditions at the time of receiving the calibration certificate, except that the analysis particle diameter was limited to a circle-equivalent diameter of 1.985 m or more and less than 39.69 m.

### EXAMPLES

The present disclosure will be explained in more detail below with reference to examples and comparative examples, but the present disclosure is not limited thereto. “Parts” used in the examples are by mass unless otherwise specified.

Below, production examples of toner will be described.

### Production Example of Pigment Dispersion Liquid 1

| | | |
|---|---|---|
| Styrene | 30.0 | parts |
| Carbon black | 8.0 | parts |
| (Product name: Nipex 35, manufactured | | |
| by Orion Engineered Carbons) | | |
| Copper phthalocyanine | 0.8 | parts |
| (Product name: C.I. Pigment Blue 15:3, | | |
| manufactured by Dainichi Seika | | |
| Color & Chemicals Mfg. Co., Ltd.) | | |
| Aluminum distearate | 0.07 | parts |

The above materials were placed in an attritor (manufactured by Mitsui Miike Chemical Engineering Co., Ltd.) and then dispersed at 220 rpm for 5 h using zirconia particles with a diameter of 1.7 mm to obtain pigment dispersion liquid 1.

### Production Examples of Pigment Dispersion Liquids 2 to 19

Pigment dispersion liquids 2 to 19 were obtained in the same manner as in the production example of pigment dispersion liquid 1, except that the types and amounts of styrene, colorant, phthalocyanine complex, and compound containing a polyvalent metal element were changed as shown in Table 1.

TABLE 1

| Pigment | | | | | Compound containing polyvalent | |
|---|---|---|---|---|---|---|
| dispersion | Styrene | Colorant | Phthalocyanine | | metal element | |
| liquid | Number | Number | | Number | | Number |
| No. | of parts | of parts | Type | of parts | Type | of parts |
| 1 | 30 | 8.0 | Copper phthalocyanine | 0.80 | Aluminum distearate | 0.07 |
| 2 | 30 | 8.0 | Zinc phthalocyanine | 0.80 | Aluminum distearate | 0.07 |
| 3 | 30 | 8.0 | Copper phthalocyanine | 0.80 | Bontron E-88 | 0.07 |
| | | | | | (Manufactured by Orient | |
| | | | | | Chemical Industries Co., Ltd.) | |
| 4 | 30 | 8.0 | Zinc phthalocyanine | 0.80 | Magnesium stearate | 0.07 |
| 5 | 30 | 8.0 | Copper phthalocyanine | 0.80 | Aluminum distearate | 0.03 |
| 6 | 30 | 8.0 | Copper phthalocyanine | 0.80 | Aluminum distearate | 0.30 |
| 7 | 30 | 8.0 | Copper phthalocyanine | 0.80 | — | 0 |
| 8 | 30 | 8.0 | Copper phthalocyanine | 0.80 | Aluminum distearate | 0.50 |
| 9 | 70 | 19.2 | Copper phthalocyanine | 9.60 | Aluminum distearate | 0.21 |
| 10 | 30 | 6.0 | Copper phthalocyanine | 0.20 | Aluminum distearate | 0.07 |
| 11 | 45 | 7.2 | Copper phthalocyanine | 7.20 | Aluminum distearate | 0.10 |
| 12 | 60 | 24.0 | Copper phthalocyanine | 0.48 | Aluminum distearate | 0.15 |
| 13 | 30 | 7.2 | Copper phthalocyanine | 0.12 | Aluminum distearate | 0.07 |
| 14 | 30 | 7.2 | Copper phthalocyanine | 0.06 | Aluminum distearate | 0.07 |
| 15 | 60 | 6.0 | Copper phthalocyanine | 12.00 | Aluminum distearate | 0.14 |
| 16 | 70 | 30.0 | Copper phthalocyanine | 0.80 | Aluminum distearate | 0.24 |
| 17 | 30 | 3.6 | Copper phthalocyanine | 0.80 | Aluminum distearate | 0.07 |
| 18 | 75 | 36 | Copper phthalocyanine | 0.80 | Aluminum distearate | 0.30 |
| 19 | 30 | 8.0 | — | 0 | Aluminum distearate | 0.07 |

### Production Example of Toner 1

| | | |
|---|---|---|
| Styrene | 47.0 | parts |
| n-Butyl acrylate | 17.0 | parts |
| Unit monomer of formula (1) | 6.0 | parts |
| Hydrocarbon wax | 5.0 | parts |
| (Product name: HNP-51, manufactured by | | |
| Nippon Seiro Co., Ltd.) | | |
| Ester compound represented by formula (4) | 12.0 | parts |
| (R⁵ = —C₂H₄—, R⁶ = R⁷ = —C₁₇H₃₅) | | |
| Ester compound represented by formula (8) | 1.0 | part |
| (R¹⁰ = —C₈H₁₆—, R₁₁ = R₁₂ = —C₂₂H₄₅) | | |
| Hexanediol diacrylate (HDDA) | 0.5 | parts |
| Acid group-containing resin | 12.0 | parts |
| (styrene - 2-hydroxyethyl methacrylate - | | |
| methacrylic acid - methyl methacrylate copolymer, | | |
| acid value 10 mg KOH/g, glass transition | | |
| temperature (Tg) 80° C., weight-average | | |
| molecular weight (Mw) 15,000) | | |

The above materials were mixed and added to 38.87 parts of pigment dispersion liquid 1. The resulting mixture was kept at 60° C. and stirred at 500 rpm using a T. K. Homomixer (manufactured by Tokushu Kika Kogyo Co., Ltd.) to dissolve and disperse uniformly, preparing a polymerizable monomer composition.

Meanwhile, 850.0 parts of 0.10 mol/L-Na₃PO₄ aqueous solution and 8.0 parts of 10% hydrochloric acid were added to a vessel equipped with a high-speed stirring device ClearMix (manufactured by M-Technique Co., Ltd.), the rotation speed was adjusted to 15,000 rpm, and the mixture was heated to 70° C. A total of 68.0 parts of 1.0 mol/L-CaCl₂ aqueous solution was added to this vessel to prepare an aqueous medium containing a calcium phosphate compound.

After the polymerizable monomer composition was added to the aqueous medium, 6.5 parts of t-butyl peroxypivalate as a polymerization initiator was added, and the mixture was granulated for 10 min while maintaining a rotation speed of 15,000 rpm. The stirrer was then changed from the high-speed stirring device to a propeller stirring blade, the mixture was reacted for 5 h at 70° C. while refluxing, the liquid temperature was then increased to 85° C., and the mixture was reacted for another 2 h.

After the polymerization reaction was completed, the obtained slurry was cooled, a portion thereof was removed, and a particle size distribution was measured. Furthermore, hydrochloric acid was added to the slurry to adjust the pH to 1.4, and the slurry was stirred for 1 h to dissolve the calcium phosphate salt. The slurry was then washed with three times the amount of water, filtered, and dried to obtain a toner particle 1. The molecular weight distribution of the toner particles was measured, and the weight-average molecular weight Mw was calculated to be 30,000.

A total of 2.0 parts of silica fine particles (number-average particle diameter of primary particles: 10 nm, BET specific surface area: 170 m²/g) hydrophobized with dimethyl silicone oil (20% by mass) and 0.05 parts of zinc stearate particles (median diameter D50s on a volume basis: 0.3 m) were added as external additives to 100.0 parts of the obtained toner particle 1, and the components were mixed for 15 min at 3000 rpm using a Mitsui Henschel mixer (manufactured by Mitsui Miike Chemical Engineering Co., Ltd.) to obtain toner 1.

### Production Examples of Toners 2 to 35

Toners 2 to 35 were obtained in the same manner as in the production example of toner 1, except that the types and amounts of pigment dispersion, styrene, n-butyl acrylate, phthalocyanine, and compound containing a polyvalent metal element were changed as shown in Tables 2-1, 2-2 and 2-3.

TABLE 2-1

| | Pigment | | | | | | |
|---|---|---|---|---|---|---|---|
| | disper- | | | | | | |
| | sion | | | | | | |
| Toner | liquid | St | n-BA | Formula (1) | | | wax |
| No. | No. | parts | parts | R1 | R2 | parts | parts |
| 1 | 1 | 47 | 17.0 | —H | —C₁₂H₂₅ | 6.0 | 5.0 |
| 2 | 2 | 47 | 17.0 | —H | —C₁₂H₂₅ | 6.0 | 5.0 |
| 3 | 1 | 47 | 17.0 | —H | —C₈H₁₇ | 6.0 | 5.0 |
| 4 | 1 | 47 | 17.0 | —CH₃ | —C₁₈H₃₇ | 6.0 | 5.0 |
| 5 | 1 | 47 | 17.0 | —H | —C₂₂H₄₅ | 6.0 | 5.0 |
| 6 | 3 | 47 | 17.0 | —H | —C₁₂H₂₅ | 6.0 | 5.0 |
| 7 | 4 | 47 | 17.0 | —H | —C₁₂H₂₅ | 6.0 | 5.0 |
| 8 | 5 | 47 | 17.0 | —H | —C₁₂H₂₅ | 6.0 | 5.0 |
| 9 | 6 | 47 | 17.0 | —H | —C₁₂H₂₅ | 6.0 | 5.0 |
| 10 | 7 | 47 | 17.0 | —H | —C₁₂H₂₅ | 6.0 | 5.0 |
| 11 | 8 | 47 | 17.0 | —H | —C₁₂H₂₅ | 6.0 | 5.0 |
| 12 | 1 | 47 | 17.0 | —H | —C₁₂H₂₅ | 6.0 | 5.0 |
| 13 | 1 | 47 | 17.0 | —H | —C₁₂H₂₅ | 6.0 | 5.0 |
| 14 | 1 | 47 | 17.0 | —H | —C₁₂H₂₅ | 6.0 | 1.8 |
| 15 | 1 | 47 | 17.0 | —H | —C₁₂H₂₅ | 6.0 | 18 |
| 16 | 1 | 47 | 17.0 | —H | —C₁₂H₂₅ | 6.0 | 0.6 |
| 17 | 1 | 47 | 17.0 | —H | —C₁₂H₂₅ | 6.0 | 21.6 |
| 18 | 9 | 7 | 17.0 | —H | —C₁₂H₂₅ | 6.0 | 5.0 |
| 19 | 10 | 47 | 17.0 | —H | —C₁₂H₂₅ | 6.0 | 5.0 |
| 20 | 11 | 32 | 17.0 | —H | —C₁₂H₂₅ | 6.0 | 5.0 |
| 21 | 12 | 17 | 17.0 | —H | —C₁₂H₂₅ | 6.0 | 5.0 |
| 22 | 13 | 47 | 17.0 | —H | —C₁₂H₂₅ | 6.0 | 5.0 |
| 23 | 14 | 47 | 17.0 | —H | —C₁₂H₂₅ | 6.0 | 5.0 |
| 24 | 15 | 17 | 17.0 | —H | —C₁₂H₂₅ | 6.0 | 5.0 |
| 25 | 16 | 7 | 17.0 | —H | —C₁₂H₂₅ | 6.0 | 5.0 |
| 26 | 17 | 47 | 17.0 | —H | —C₁₂H₂₅ | 6.0 | 5.0 |
| 27 | 18 | 2 | 17.0 | —H | —C₁₂H₂₅ | 6.0 | 5.0 |
| 28 | 1 | 47 | 22.0 | —H | —C₁₂H₂₅ | 1.0 | 5.0 |
| 29 | 1 | 47 | 8.0 | —H | —C₁₂H₂₅ | 15.0 | 5.0 |
| 30 | 1 | 47 | 22.5 | —H | —C₁₂H₂₅ | 0.5 | 5.0 |
| 31 | 1 | 47 | 5.0 | —H | —C₁₂H₂₅ | 18.0 | 5.0 |
| 32 | 1 | 47 | 23.0 | — | — | 0 | 5.0 |
| 33 | 1 | 47 | 17.0 | —H | —CH₂CHC₂H₅C₄H₉ | 6.0 | 5.0 |
| 34 | 19 | 47 | 17.0 | —H | —C₁₂H₂₅ | 6.0 | 5.0 |
| 35 | 1 | 47 | 17.0 | —H | —C₁₂H₂₅ | 6.0 | 0.0 |

In the tables 2-1, 2-2 and 2-3, St represents styrene, n-BA represents n-butyl acrylate, and wax represents hydrocarbon wax.

TABLE 2-2

| Toner | Ester compounds represented by formulas (3) to (5) | | | | | |
|---|---|---|---|---|---|---|
| No. | Formula | R3 | R4 | R5 | R6 | R7 |
| 1 | (4) | — | — | —C₂H₄— | —C₁₇H₃₅ | —C₁₇H₃₅ |
| 2 | (4) | — | — | —CH₂— | —C₁₄H₂₉ | —C₁₄H₂₉ |
| 3 | (4) | — | — | —C₆H₁₂— | —C₂₂H₄₅ | —C₂₂H₄₅ |
| 4 | (3) | —C₁₈H₃₇ | —C₁₈H₃₇ | — | — | — |
| 5 | (3) | —C₁₆H₃₃ | —C₁₆H₃₃ | — | — | — |
| 6 | (4) | — | — | —C₂H₄— | —C₁₇H₃₅ | —C₁₇H₃₅ |
| 7 | (4) | — | — | —C₂H₄— | —C₁₇H₃₅ | —C₁₇H₃₅ |
| 8 | (3) | —C₂₂H₄₅ | —C₁₈H₃₇ | — | — | — |
| 9 | (5) | — | — | —C₂H₄— | —C₁₈H₃₇ | —C₁₈H₃₇ |
| 10 | (4) | — | — | —C₂H₄— | —C₁₇H₃₅ | —C₁₇H₃₅ |
| 11 | (4) | — | — | —C₂H₄— | —C₁₇H₃₅ | —C₁₇H₃₅ |
| 12 | (4) | — | — | —C₂H₄— | —C₁₇H₃₅ | —C₁₇H₃₅ |
| 13 | — | — | — | — | — | — |
| 14 | (4) | — | — | —C₂H₄— | —C₁₇H₃₅ | —C₁₇H₃₅ |
| 15 | (4) | — | — | —C₂H₄— | —C₁₇H₃₅ | —C₁₇H₃₅ |
| 16 | (4) | — | — | —C₂H₄— | —C₁₇H₃₅ | —C₁₇H₃₅ |
| 17 | (4) | — | — | —C₂H₄— | —C₁₇H₃₅ | —C₁₇H₃₅ |
| 18 | (4) | — | — | —C₇H₁₄— | —C₂₃H₄₇ | —C₂₃H₄₇ |
| 19 | (3) | —C₁₅H₃₁ | —C₁₅H₃₁ | — | — | — |
| 20 | (4) | — | — | —C₂H₄— | —C₁₇H₃₅ | —C₁₇H₃₅ |
| 21 | (4) | — | — | —C₂H₄— | —C₁₇H₃₅ | —C₁₇H₃₅ |
| 22 | (4) | — | — | —C₂H₄— | —C₁₇H₃₅ | —C₁₇H₃₅ |
| 23 | (4) | — | — | —C₂H₄— | —C₁₇H₃₅ | —C₁₇H₃₅ |
| 24 | (4) | — | — | —C₂H₄— | —C₁₇H₃₅ | —C₁₇H₃₅ |
| 25 | (4) | — | — | —C₂H₄— | —C₁₇H₃₅ | —C₁₇H₃₅ |
| 26 | (4) | — | — | —C₂H₄— | —C₁₇H₃₅ | —C₁₇H₃₅ |
| 27 | (4) | — | — | —C₂H₄— | —C₁₇H₃₅ | —C₁₇H₃₅ |
| 28 | (5) | — | — | —C₇H₁₄— | —C₂₃H₄₇ | —C₂₃H₄₇ |
| 29 | (4) | — | — | —C₂H₄— | —C₁₇H₃₅ | —C₁₇H₃₅ |
| 30 | (4) | — | — | —C₂H₄— | —C₁₇H₃₅ | —C₁₇H₃₅ |
| 31 | (4) | — | — | —C₂H₄— | —C₁₇H₃₅ | —C₁₇H₃₅ |
| 32 | (4) | — | — | —C₂H₄— | —C₁₇H₃₅ | —C₁₇H₃₅ |
| 33 | (4) | — | — | —C₂H₄— | —C₁₇H₃₅ | —C₁₇H₃₅ |
| 34 | (4) | — | — | —C₂H₄— | —C₁₇H₃₅ | —C₁₇H₃₅ |
| 35 | (4) | — | — | —C₂H₄— | —C₁₇H₃₅ | —C₁₇H₃₅ |

TABLE 2-3

| Toner | Ester compounds represented by formulas (6) to (8) | | | | | |
|---|---|---|---|---|---|---|
| No. | Formula | R8 | R9 | R10 | R11 | R12 |
| 1 | (8) | — | — | —C₈H₁₆— | —C₂₂H₄₅ | —C₂₂H₄₅ |
| 2 | (8) | — | — | —C₈H₁₆— | —C₁₈H₃₇ | —C₁₈H₃₇ |
| 3 | (8) | — | — | —C₁₂H₂₄— | —C₂₂H₄₅ | —C₂₂H₄₅ |
| 4 | (7) | — | — | —C₁₀H₂₀— | —C₂₁H₄₃ | —C₂₁H₄₃ |
| 5 | (6) | —C₂₁H₄₃ | —C₂₂H₄₅ | — | — | — |
| 6 | (8) | — | — | —C₈H₁₆— | —C₂₂H₄₅ | —C₂₂H₄₅ |
| 7 | (8) | — | — | —C₈H₁₆— | —C₂₂H₄₅ | —C₂₂H₄₅ |
| 8 | (8) | — | — | —C₁₃H₂₆— | —C₂₃H₄₇ | —C₂₃H₄₇ |
| 9 | (7) | — | — | —C₁₃H₂₆— | —C₂₃H₄₇ | —C₂₃H₄₇ |
| 10 | (8) | — | — | —C₈H₁₆— | —C₂₂H₄₅ | —C₂₂H₄₅ |
| 11 | (8) | — | — | —C₈H₁₆— | —C₂₂H₄₅ | —C₂₂H₄₅ |
| 12 | — | — | — | — | — | — |
| 13 | (8) | — | — | —C₈H₁₆— | —C₂₂H₄₅ | —C₂₂H₄₅ |
| 14 | (8) | — | — | —C₈H₁₆— | —C₂₂H₄₅ | —C₂₂H₄₅ |
| 15 | (8) | — | — | —C₈H₁₆— | —C₂₂H₄₅ | —C₂₂H₄₅ |
| 16 | (8) | — | — | —C₈H₁₆— | —C₂₂H₄₅ | —C₂₂H₄₅ |
| 17 | (8) | — | — | —C₈H₁₆— | —C₂₂H₄₅ | —C₂₂H₄₅ |
| 18 | (8) | — | — | —C₈H₁₆— | —C₂₂H₄₅ | —C₂₂H₄₅ |
| 19 | (8) | — | — | —C₈H₁₆— | —C₂₂H₄₅ | —C₂₂H₄₅ |
| 20 | (8) | — | — | —C₈H₁₆— | —C₂₂H₄₅ | —C₂₂H₄₅ |
| 21 | (8) | — | — | —C₈H₁₆— | —C₂₂H₄₅ | —C₂₂H₄₅ |
| 22 | (8) | — | — | —C₈H₁₆— | —C₂₂H₄₅ | —C₂₂H₄₅ |
| 23 | (8) | — | — | —C₈H₁₆— | —C₂₂H₄₅ | —C₂₂H₄₅ |
| 24 | (8) | — | — | —C₈H₁₆— | —C₂₂H₄₅ | —C₂₂H₄₅ |
| 25 | (8) | — | — | —C₈H₁₆— | —C₂₂H₄₅ | —C₂₂H₄₅ |
| 26 | (8) | — | — | —C₈H₁₆— | —C₂₂H₄₅ | —C₂₂H₄₅ |
| 27 | (8) | — | — | —C₈H₁₆— | —C₂₂H₄₅ | —C₂₂H₄₅ |
| 28 | (8) | — | — | —C₈H₁₆— | —C₂₂H₄₅ | —C₂₂H₄₅ |
| 29 | (8) | — | — | —C₈H₁₆— | —C₂₂H₄₅ | —C₂₂H₄₅ |
| 30 | (8) | — | — | —C₈H₁₆— | —C₂₂H₄₅ | —C₂₂H₄₅ |
| 31 | (8) | — | — | —C₈H₁₆— | —C₂₂H₄₅ | —C₂₂H₄₅ |
| 32 | (8) | — | — | —C₈H₁₆— | —C₂₂H₄₅ | —C₂₂H₄₅ |
| 33 | (8) | — | — | —C₈H₁₆— | —C₂₂H₄₅ | —C₂₂H₄₅ |
| 34 | (8) | — | — | —C₈H₁₆— | —C₂₂H₄₅ | —C₂₂H₄₅ |
| 35 | (8) | — | — | —C₈H₁₆— | —C₂₂H₄₅ | —C₂₂H₄₅ |

### Production of Magnetic Body 1

A total of 55 L of a 4.0 mol/L aqueous solution of sodium hydroxide was mixed and stirred with 50 L of an aqueous solution of ferrous sulfate containing 2.0 mol/L of Fe²⁺ to obtain an aqueous solution of ferrous salt containing ferrous hydroxide colloid. This aqueous solution was kept at 85° C., and an oxidation reaction was carried out while blowing in air at 20 L/min to obtain a slurry containing core particles. The obtained slurry was filtered with a filter press and washed, after which the core particles were dispersed again in water to be reslurried. Sodium silicate equivalent to 0.2% by mass silicon per 100.0 parts of core particles was added to this reslurry liquid, the pH of the slurry liquid was adjusted to 6.0, and the mixture was stirred to obtain magnetic iron oxide particles with a silicon-rich surface.

The obtained slurry was filtered with a filter press, washed, and then reslurried with ion-exchanged water. A total of 500.0 parts (10.0% by mass relative to the magnetic iron oxide) of ion-exchange resin (product name: SKi10, manufactured by Mitsubishi Chemical Corporation) was added to this reslurry liquid (solid content 50 g/L) and stirred for 2 h to perform ion exchange. The ion-exchange resin was then removed by filtration with a mesh, filtered with a filter press, washed, dried and pulverized to obtain magnetic iron oxide with a number-average particle diameter of 0.23 m.

Next, a surface treatment agent was prepared. A total of 30.0 parts of iso-butyltrimethoxysilane was dropped into 70.0 parts of ion-exchanged water while stirring. The aqueous solution was then kept at pH 5.5 and a temperature of 55° C., and dispersed for 120 min at a peripheral speed of 0.46 m/s using a dispersing blade to perform hydrolysis. The pH of the aqueous solution was then adjusted to 7.0, and the solution was cooled to 10° C. to stop the hydrolysis reaction. An aqueous solution including a silane compound was thus obtained.

A total of 100.0 parts of magnetic iron oxide was placed in a high-speed mixer (product name: LFS-2 type, manufactured by Fukae Powtec Co., Ltd.), and while stirring at a rotation speed of 2000 rpm, 8.0 parts of an aqueous solution containing a silane compound was added dropwise over a period of 2 min. The components were then mixed and stirred for 5 min. Next, in order to increase the adhesion of the silane compound, it was dried at 40° C. for 1 h to reduce the moisture content, and then the mixture was dried at 110° C. for 3 h to allow the condensation reaction of the silane compound to proceed. Subsequent pulverization and passing through a sieve with a mesh size of 100 m produced magnetic body 1.

### Production Example of Toner 36

A total of 450 parts of 0.1 mol/L-NaPO₄ aqueous solution was added to 720 parts of ion-exchanged water and heated to 60° C., after which 67.7 parts of 1.0 mol/L-CaCl₂ aqueous solution was added to obtain an aqueous medium containing a dispersion stabilizer.

Then, the following materials were prepared.

| | | |
|---|---|---|
| Styrene | 81.0 | parts |
| n-Butyl acrylate | 13.0 | parts |
| n-Lauryl acrylate | 6.0 | parts |
| Hexanediol diacrylate (HDDA) | 1.5 | parts |
| Magnetic body 1 | 65.0 | parts |
| Polar resin (polyester resin, acid value: | 4.0 | parts |
| 8.0 mg KOH/g, glass transition | | |

temperature: 69° C., weight-average
molecular weight: 9500)

These materials were uniformly dispersed and mixed using an attritor (manufactured by Nippon Coke and Engineering Co., Ltd.). The resulting monomer composition was heated to a temperature of 60° C., and the following materials were mixed and dissolved therein to prepare a polymerizable monomer composition.

| | | |
|---|---|---|
| Ester compound represented by formula (4) | 15.0 | parts |
| (R⁵ = —C₂H₄—, R⁶ = R⁷ = —C₁₇H₃₅) | | |
| Hydrocarbon wax | 5.0 | parts |
| (Product name: HNP-51, manufactured | | |
| by Nippon Seiro Co., Ltd.) | | |
| Polymerization initiator | 9.0 | parts |
| (t-butyl peroxypivalate) | | |

The polymerizable monomer composition was added to the aqueous medium obtained above, and a granulation process was carried out for 10 min at a temperature of 60° C. and under a nitrogen atmosphere using Clearmix (manufactured by M-Technique Co., Ltd.) while maintaining 15,000 rpm.

Then, stirring was performed with a paddle stirring blade, and a polymerization reaction was carried out for 300 min at a reaction temperature of 70° C. After completion of the reaction, the temperature of the suspension was raised to 100° C. and held for 2 h. Then, as a cooling step, 0° C. water was added to the suspension and the suspension was cooled from 98° C. to 30° C. at a rate of 60° C./min. After that, the dispersion stabilizer was dissolved by adding hydrochloric acid to the suspension and thoroughly washing, and the suspension was filtered and dried to obtain the toner particle.

The obtained toner particle were subjected to external addition treatment in the same manner as in the production example of toner 1 to obtain toner 36.

Table 3 shows the content of the monomer unit represented by formula (1) in the vinyl resin of each toner, the content of carbon black, phthalocyanine complex, and hydrocarbon wax per 100 parts by mass of the binder resin, the ratio a/b of the content a (% by mass) of carbon black based on the mass of the black toner particle to the total content b (% by mass) of copper phthalocyanine and zinc phthalocyanine, and the mass concentration of polyvalent metal element in the toner particle.

TABLE 3

| | Ratio of | Number of parts by mass of each material | | | | Mass concentration | |
|---|---|---|---|---|---|---|---|
| | formula | in relation to 100 parts of binder resin | | | | of polyvalent metal | |
| Toner | (1) in | Carbon | Phthalocyanine | Hydrocarbon | | element in toner | |
| No. | vinyl resin | black | compound | wax | a/b | particle | |
| 1 | 6.0% | 6.7 | 0.67 | 4.2 | 10.0 | 10 | ppm |
| 2 | 6.0% | 6.7 | 0.67 | 4.2 | 10.0 | 10 | ppm |
| 3 | 6.0% | 6.7 | 0.67 | 4.2 | 10.0 | 10 | ppm |
| 4 | 6.0% | 6.7 | 0.67 | 4.2 | 10.0 | 10 | ppm |
| 5 | 6.0% | 6.7 | 0.67 | 4.2 | 10.0 | 10 | ppm |
| 6 | 6.0% | 6.7 | 0.67 | 4.2 | 10.0 | 10 | ppm |
| 7 | 6.0% | 6.7 | 0.67 | 4.2 | 10.0 | 10 | ppm |
| 8 | 6.0% | 6.7 | 0.67 | 4.2 | 10.0 | 5 | ppm |
| 9 | 6.0% | 6.7 | 0.67 | 4.2 | 10.0 | 500 | ppm |
| 10 | 6.0% | 6.7 | 0.67 | 4.2 | 10.0 | 0 | |
| 11 | 6.0% | 6.7 | 0.67 | 4.2 | 10.0 | 700 | ppm |
| 12 | 6.0% | 6.7 | 0.67 | 4.2 | 10.0 | 10 | ppm |
| 13 | 6.0% | 6.7 | 0.67 | 4.2 | 10.0 | 10 | ppm |
| 14 | 6.0% | 6.7 | 0.67 | 1.5 | 10.0 | 10 | ppm |
| 15 | 6.0% | 6.7 | 0.67 | 15.0 | 10.0 | 10 | ppm |
| 16 | 6.0% | 6.7 | 0.67 | 0.5 | 10.0 | 10 | ppm |
| 17 | 6.0% | 6.7 | 0.67 | 18 | 10.0 | 10 | ppm |
| 18 | 6.0% | 16.0 | 8.00 | 4.2 | 2.0 | 26 | ppm |
| 19 | 6.0% | 5.0 | 0.17 | 4.2 | 30.0 | 10 | ppm |
| 20 | 6.0% | 6.0 | 6.00 | 4.2 | 1.0 | 13 | ppm |
| 21 | 6.0% | 20.0 | 0.40 | 4.2 | 50.0 | 18 | ppm |
| 22 | 6.0% | 6.0 | 0.10 | 4.2 | 60.0 | 10 | ppm |
| 23 | 6.0% | 6.0 | 0.05 | 4.2 | 120.0 | 10 | ppm |
| 24 | 6.0% | 6.0 | 12.00 | 4.2 | 0.5 | 19 | ppm |
| 25 | 6.0% | 25.0 | 0.67 | 4.2 | 37.5 | 29 | ppm |
| 26 | 6.0% | 3.0 | 0.67 | 4.2 | 4.5 | 10 | ppm |
| 27 | 6.0% | 30.0 | 0.67 | 4.2 | 45.0 | 34 | ppm |
| 28 | 1.0% | 6.7 | 0.67 | 4.2 | 10.0 | 10 | ppm |
| 29 | 15.0% | 6.7 | 0.67 | 4.2 | 10.0 | 9 | ppm |
| 30 | 0.5% | 6.7 | 0.67 | 4.2 | 10.0 | 10 | ppm |
| 31 | 18.0% | 6.7 | 0.67 | 4.2 | 10.0 | 9 | ppm |
| 32 | 0.0% | 6.7 | 0.67 | 4.2 | 10.0 | 10 | ppm |
| 33 | 6.0% | 6.7 | 0.67 | 4.2 | 10.0 | 10 | ppm |
| 34 | 6.0% | 6.7 | — | 4.2 | — | 10 | ppm |
| 35 | 6.0% | 6.7 | 0.67 | — | 10.0 | 10 | ppm |

| | | | | | | |
|---|---|---|---|---|---|---|
| 36 | 6.0% | — | — | 4.4 | — | — |

The ratio of formula (1) in the vinyl resin indicates the content ratio (% by mass) of the monomer unit represented by formula (1) in the vinyl resin.

The obtained toners were used to perform the following evaluations.

### Image Evaluation

The image evaluation was performed using a commercially available color laser printer (HP LaserJet Enterprise Color M555dn, manufactured by HP) that had been partially modified. The modification was made so that the printer could operate even with only one color process cartridge installed. The toner was removed from the black cartridge and replaced with 100 g of the toner to be evaluated, and the evaluation was performed.

### Evaluation Method for Cold Offset

The cold offset evaluation was performed in a normal temperature and humidity environment (temperature 25.0° C., relative humidity 50%). The evaluation electrophotographic apparatus was modified so that the fixing temperature of the fixing unit in the evaluation electrophotographic apparatus could be set feely. In this apparatus, the temperature of the fixing unit was adjusted in 5° C. increments within the range of from 140° C. to 180° C., and smooth paper GF-C081 (manufactured by Canon Marketing Japan, basis weight 81.4 g/cm², A4) was used as the medium. Three solid black images with a toner laid-on level of 0.40 mg/cm² were printed. At this time, the solid image area of the third sheet was visually evaluated for the presence or absence of cold offset, and the lowest temperature at which cold offset did not occur was used for evaluation according to the following criteria:
A: Less than 150° C.
B: 150° C. or more and less than 160° C.
C: 160° C. or more and less than 170° C.
D: 170° C. or more and less than 180° C.
E: 180° C. or more

### Evaluation Method for Blank Dots

To evaluate the blank dots, the medium was changed to Vitality (manufactured by Xerox Corp., basis weight 75 g/cm², letter), which is plain paper, and the image was output under the same conditions as in the evaluation method for cold offset. At this time, the solid image area of the third sheet was visually evaluated for the presence or absence of white areas where the toner was missing, and the lowest temperature at which blank dots did not occur was used for evaluation according to the following criteria:
A: Less than 150° C.
B: 150° C. or more, less than 160° C.
C: 160° C. or more, less than 170° C.
D: 170° C. or more, less than 180° C.
E: 180° C. or more

### Image Density (Tinting Strength)

Image density was evaluated using the print image at the lowest fixing temperature in the above fixing test. The image density was measured using a “Macbeth Reflection Densitometer RD918” (manufactured by Macbeth Co., Ltd.), the relative density to the printout image of the white background part with an original density of 0.00 was measured, and the image density was evaluated using the average value of the measurements taken at three points on the left, center, and right sides of the output image.
A: Image density is 1.40 or more
B: Image density is 1.30 or more and less than 1.40
C: Image density is 1.20 or more and less than 1.30
D: Image density is less than 1.20

### Image Gloss Stability

The image printed at the lowest fixing temperature in the above low-temperature fixing test was allowed to stand for one day in a normal temperature and humidity environment (temperature 23° C., relative humidity 60%), and then the image gloss of the fixed image was measured. A handy gloss meter PG-1 (manufactured by Nippon Denshoku Industries Co., Ltd.) was used to measure the image gloss. The measurement conditions were set to 750 for the projection angle and the reception angle, measurements were taken at five different points on the fixed image, and the average value was taken as the initial gloss value after fixing.

In addition, the image on which gloss was measured was allowed to stand for two weeks in an environment of 50° C. and relative humidity 30%, and then allowed to stand for one day in a normal temperature and humidity environment (temperature 23° C., relative humidity 60%). Then, the image gloss was measured. A comparison was made with the initial gloss value after fixing. Image gloss stability was evaluated according to the following criteria.
A: Image gloss change range (Δgloss) is 3 or less
B: Image gloss change range is more than 3 and 6 or less
C: Image gloss change range is more than 6 and 10 or less
D: Image gloss change is more than 10 and 15 or less
E: Image gloss change range is greater than 15

### Examples 1 to 31

In Examples 1 to 31, the above evaluation was performed using toners 1 to 31, respectively. The evaluation results are shown in Table 4.

TABLE 4

| | | | | | | | | Gloss | | |
|---|---|---|---|---|---|---|---|---|---|---|
| | | Cold offset | | Blank dots | | Image density | | | Gloss after 2 | |
| Example | Toner | Temp. | | Temp. | | Average | | Initial | weeks at 50° C. | |
| No. | No. | ° C. | Rank | ° C. | Rank | value | Rank | gloss | Δgloss | Rank |
| 1 | 1 | 140 | A | 140 | A | 1.50 | A | 62 | 0 | A |
| 2 | 2 | 140 | A | 140 | A | 1.49 | A | 61 | 0 | A |
| 3 | 3 | 140 | A | 145 | A | 1.46 | A | 62 | 1 | A |
| 4 | 4 | 140 | A | 145 | A | 1.50 | A | 61 | 1 | A |
| 5 | 5 | 140 | A | 140 | A | 1.47 | A | 63 | 0 | A |
| 6 | 6 | 140 | A | 145 | A | 1.38 | B | 65 | 1 | A |
| 7 | 7 | 140 | A | 145 | A | 1.34 | B | 63 | 2 | A |
| 8 | 8 | 140 | A | 145 | A | 1.48 | A | 62 | 1 | A |
| 9 | 9 | 145 | A | 145 | A | 1.41 | A | 64 | 2 | A |
| 10 | 10 | 145 | A | 155 | B | 1.45 | A | 63 | 1 | A |
| 11 | 11 | 145 | A | 145 | A | 1.28 | C | 62 | 2 | A |
| 12 | 12 | 150 | B | 155 | B | 1.42 | A | 64 | 10 | C |
| 13 | 13 | 165 | C | 165 | C | 1.44 | A | 62 | 2 | A |
| 14 | 14 | 145 | A | 145 | A | 1.46 | A | 64 | 1 | A |
| 15 | 15 | 140 | A | 145 | A | 1.41 | A | 62 | 2 | A |
| 16 | 16 | 150 | B | 160 | C | 1.47 | A | 60 | 0 | A |
| 17 | 17 | 150 | B | 140 | A | 1.35 | B | 61 | 5 | B |
| 18 | 18 | 145 | A | 145 | A | 1.43 | A | 63 | 1 | A |
| 19 | 19 | 145 | A | 145 | A | 1.40 | A | 62 | 2 | A |
| 20 | 20 | 145 | A | 150 | B | 1.33 | B | 61 | 1 | A |
| 21 | 21 | 145 | A | 155 | B | 1.53 | A | 65 | 1 | A |
| 22 | 22 | 145 | A | 155 | B | 1.45 | A | 63 | 0 | A |
| 23 | 23 | 155 | B | 160 | C | 1.43 | A | 63 | 1 | A |
| 24 | 24 | 145 | A | 140 | A | 1.26 | C | 62 | 2 | A |
| 25 | 25 | 145 | A | 150 | B | 1.55 | A | 60 | 1 | A |
| 26 | 26 | 140 | A | 140 | A | 1.21 | C | 62 | 0 | A |
| 27 | 27 | 155 | B | 160 | C | 1.59 | A | 61 | 2 | A |
| 28 | 28 | 145 | A | 140 | A | 1.47 | A | 64 | 1 | A |
| 29 | 29 | 140 | A | 145 | A | 1.43 | A | 63 | 2 | A |
| 30 | 30 | 160 | C | 150 | B | 1.45 | A | 62 | 0 | A |
| 31 | 31 | 140 | A | 160 | C | 1.48 | A | 61 | 6 | B |
| C.E. 1 | 32 | 180 | E | 170 | D | 1.47 | A | 63 | 1 | A |
| C.E. 2 | 33 | 175 | D | 175 | D | 1.49 | A | 60 | 0 | A |
| C.E. 3 | 34 | 165 | C | 180 | E | 1.38 | B | 64 | 2 | A |
| C.E. 4 | 35 | 160 | C | 175 | D | 1.45 | A | 62 | 1 | A |
| C.E. 5 | 36 | 175 | D | 175 | D | 1.43 | A | 62 | 15 | E |

In the Table 4, “C.E.” indicates “Comparative Example”, and “Temp.” indicates Temperature.

### Comparative Examples 1 to 5

In Comparative Examples 1 to 5, the above evaluation was performed using toners 32 to 36, respectively. The evaluation results are shown in Table 4.

According to the present disclosure, it is possible to provide a toner that suppresses the occurrence of both cold offset and blank dots.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159822, filed Sep. 17, 2024, which is hereby incorporated by reference herein in its entirety.

What is claimed is:

1. A black toner comprising a black toner particle comprising
a binder resin,
a hydrocarbon wax, and
carbon black, wherein
the black toner particle further comprises at least one selected from the group consisting of copper phthalocyanine and zinc phthalocyanine, and
the binder resin comprises a vinyl resin having a monomer unit represented by the following formula (1): 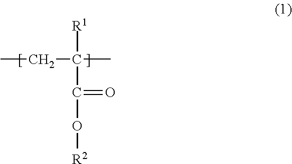
where, in formula (1), R¹ represents a hydrogen atom or a methyl group, and R² represents a linear alkyl group having 8 to 22 carbon atoms.

2. The black toner according to claim 1, wherein the vinyl resin comprises 1.0% by mass to 15.0% by mass of the monomer unit represented by formula (1).

3. The black toner according to claim 1, wherein content of the carbon black is 5.0 parts by mass to 25.0 parts by mass relative to 100 parts by mass of the binder resin.

4. The black toner according to claim 1, wherein total content of the copper phthalocyanine and the zinc phthalocyanine is 0.10 parts by mass to 8.00 parts by mass relative to 100 parts by mass of the binder resin.

5. The black toner according to claim 1, wherein where content of the carbon black based on the mass of the black toner particle is denoted by a (% by mass), and total content of the copper phthalocyanine and the zinc phthalocyanine based on the mass of the black toner particle is denoted by b (% by mass), a and b satisfy a following formula (2):
$$2. \leq a / b \leq 30. \qquad ( 2 )$$

6. The black toner according to claim 1, wherein content of the hydrocarbon wax is 1.5 parts by mass to 15.0 parts by mass relative to 100 parts by mass of the binder resin.

7. The black toner according to claim 1, wherein
the black toner particle comprises
a first ester compound which is at least one ester compound selected from the group consisting of an ester compound represented by a following formula (3), an ester compound represented by a following formula (4), and an ester compound represented by a following formula (5), and
a second ester compound which is at least one ester compound selected from the group consisting of an ester compound represented by a following formula (6), an ester compound represented by a following formula (7), and an ester compound represented by a following formula (8): 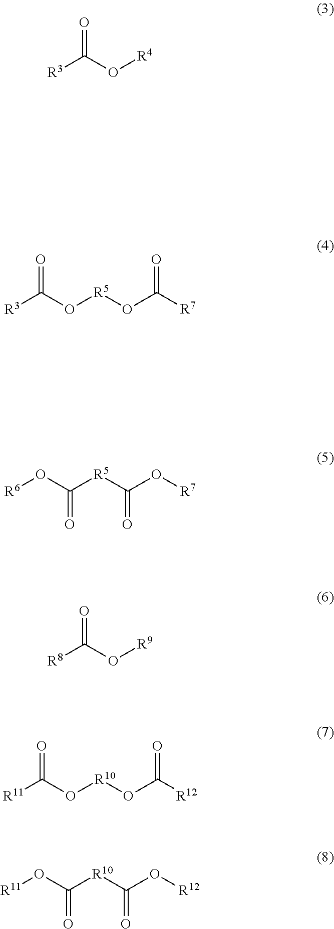
where, in formula (3), R³ and R⁴ each independently represent a linear alkyl group having 16 to 22 carbon atoms (however, when R³ has 18 to 22 carbon atoms, this does not include the case where R⁴ has 19 to 22 carbon atoms),
in formula (4), R⁵ represents a linear alkylene group having 1 to 6 carbon atoms, and R⁶ and R⁷ each independently represent a linear alkyl group having 14 to 22 carbon atoms,
in formula (5), R⁵ represents a linear alkylene group having 1 to 6 carbon atoms, and R⁶ and R⁷ each independently represent a linear alkyl group having 14 to 22 carbon atoms,
in formula (6), R⁸ represents a linear alkyl group having 21 carbon atoms, and R⁹ represents a linear alkyl group having 22 carbon atoms,
in formula (7), R¹⁰ represents a linear alkylene group having 8 to 12 carbon atoms, and R¹¹ and R¹² each independently represent a linear alkyl group having 18 to 22 carbon atoms, and
in formula (8), R¹⁰ represents a linear alkylene group having 8 to 12 carbon atoms, and R¹¹ and R¹² each independently represent a linear alkyl group having 18 to 22 carbon atoms.

8. The black toner according to claim 1, wherein
the black toner particle comprises a polyvalent metal element,
the polyvalent metal element comprises at least one selected from the group consisting of aluminum and magnesium, and
mass concentration of the polyvalent metal element in the black toner particle is 5 ppm to 500 ppm.

9. The black toner according to claim 1, wherein the black toner particle comprises aluminum distearate.
